(19) United States
(12) Patent Application Publication
(10) Pub. No.: US 2018/0283148 A1
(43) Pub. Date: Oct. 4, 2018

(54) AUTOMATED LIFT-GAS BALANCING IN OIL PRODUCTION

(71) Applicant: HALLIBURTON ENERGY SERVICES, INC., HOUSTON, TX (US)

(72) Inventor: Thomas Manuel Ortiz, Houston, TX (US)

(21) Appl. No.: 15/765,211

(22) PCT Filed: Oct. 30, 2015
(86) PCT No.: PCT/US2015/058360

§ 371 Date: Mar. 30, 2018

(51) Int. Cl. E21B 43/12; G05B 19/042; G05D 7/06; G05D 16/20

(52) U.S. Cl. CPC E21B 43/122; G05B 19/042; G05B 2219/21109; G05D 16/2026; G05D 7/0641

(57) ABSTRACT

A system for automatically and optimally balancing lift gas in a pipeline network for lift-gas wells of an oil field. The system includes peer-to-peer sensors for (1) generating local gas values, (2) receiving system data including local gas target values for each of the sensors and first local gas request parameters from at least one other sensor, (3) controlling a corresponding flow control device based on the local gas values and target local gas values for the sensor, and the first local gas request parameters, (4) calculating second local gas request parameters for the sensor based on the local gas values, the local target values, and the system data; and (5) transmitting the system data including the second local gas request parameters to at least one other sensor.

### BACKGROUND

In oil production, crude oil is initially recovered from underground reservoirs or oil fields by exploiting a pressure differential between the reservoir and a well at ground or sea level to bring the oil up to the surface through a wellbore. More specifically, when the reservoir pressure is sufficient to overcome the hydrostatic gradient and frictional pressure losses incurred as the fluid moves through the wellbore and through surface production facilities, oil and gas will flow naturally. Where natural reservoir pressure is insufficient, the differential can be created by, for example, using a pump at the bottom of a wellbore to lift the oil to the surface or injecting gas for pressure maintenance into the reservoir Alternatively, additional fluid, called lift gas, may be injected into a wellbore or production string to decrease the density of the oil, thereby decreasing the hydrostatic gradient, which allows the existing reservoir pressure to lift the less-dense fluid to the surface. The lift gas can come from compressed gas at the surface which is injected down the wellbore. Or it can come from another reservoir or formation penetrated by the wellbore in a technique called autolifting. Pumping and gas lift are collectively referred to as artificial lifting mechanisms.

Over the course of production of a reservoir, reservoir pressure decreases. Thus, a well initially producing oil naturally may later need increasing amounts of gas injection to continue producing oil. Also, a well can produce crude oil, hydrocarbon gas or other gases, or a combination of oil and gas. The produced gas can be used as lift gas for the well or for another well.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic view, partly in cross-section, of an on-shore drilling apparatus.

FIG. 2 illustrates an automated lift-gas balancing system including different lift-gas sources, different gas-lifted or lift-gas wells, different gas customers, a gas pipeline network therebetween, and a communication and control network.

FIG. 3 is s simplified schematic view of a sensor used in a lift-gas balancing system.

FIG. 4 is schematic view of the input/output devices of a sensor that obtains local gas values from a pipeline in a gas pipeline network, and controls the flow of gas in the pipeline

FIG. 5 is a flow chart of an exemplary process performed by a sensor in a lift-gas balancing system.

### DETAILED DESCRIPTION

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict, for example, a horizontal, planar pipeline network having inputs in one section and outputs on another section, unless otherwise indicated otherwise, it should be understood by those skilled in the art that the apparatus according to the present disclosure is equally well suited for use in networks having other orientations and other points for inputs and outputs. Likewise, unless otherwise noted, even though a Figure may depict an onshore operation, it should be understood by those skilled in the art that the apparatus according to the present disclosure is equally well suited for offshore operation.

Generally, in one or more embodiments, a system is provided that automatically, controllably, and optimally balances lift gas for oil production in an oil field. The lift gas is carried between instrumented oil and gas wells, other gas sources, and gas customers through a pipeline network. Some or all of the oil wells are produced using lift gas, and others are produced by either natural or alternative artificial lifting methods. Gas production rates from wells will change, typically decreasing over time. Lift-gas demands in gas lifted wells will also change, typically increasing over time. Prices and availability of other sources of lift gas will also change based on composition of the lift gas, market prices of the gas components therein, and the like. Customers will have different and changing demands for gas based on, for example, their own valuation and the market prices of the various components of the gas. These changes in gas produced from wells (“well gas”), external lift-gas sources (“external gas”) such as pipelines, at import or input points, and customer and lift-gas well demands at export or output points, provide operating companies with profit maximization opportunities by optimally balancing or allocating lift gas among the various input and output points. Periodic or continuous allocation of available gas for maximum oil production (or profit) is achieved by honoring set points from well models associated with a production forecast. Where operational realities conflict with the models, the forecasts can in turn be updated with as-operated lift-gas allocation data to form a feedback loop. Also, embodiments of the system are able to but are not required to rapidly and gracefully rebalance lift-gas distribution through the network within constraints despite events such as sudden loss of well gas, external lift gas, compressor capacity, import points, or output points.

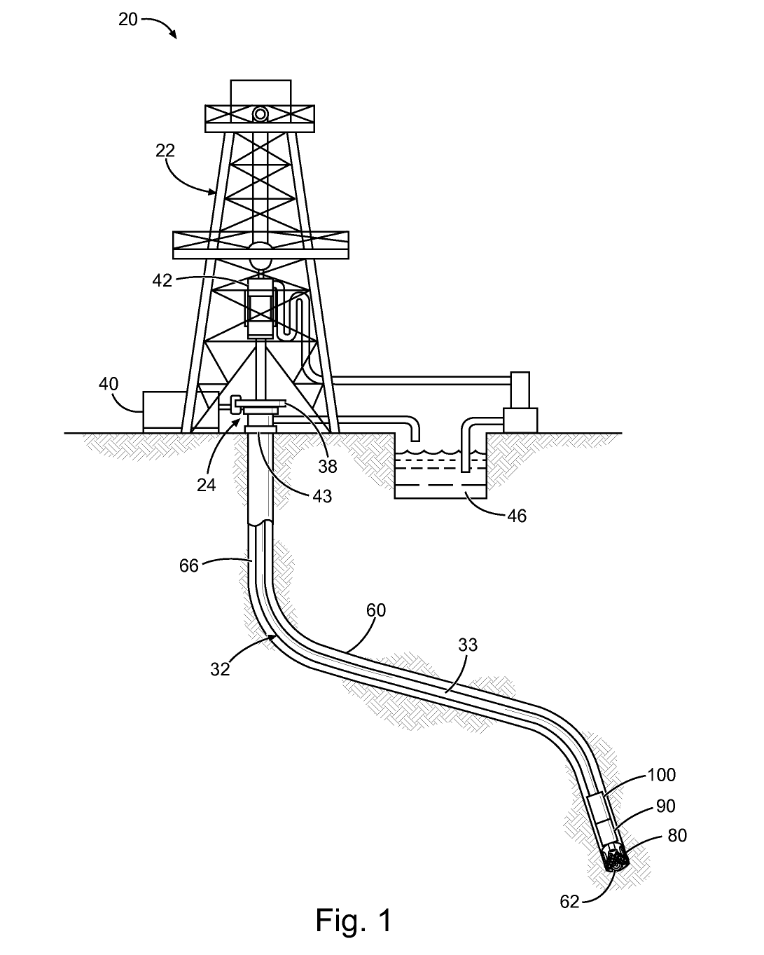

FIG. 1 is an elevation view in partial cross-section of an on-shore drilling system 20 to develop a crude oil and well-gas source for use in the automated lift-gas balancing system. The drilling system 20 recovers oil and gas from a wellbore 60 extending through various earth strata in an oil and gas formation located below the earth's surface. Drilling system 20 may include a drilling rig 22, such as the land drilling rig shown in FIG. 1. However, drilling system 20 may be deployed on offshore platforms, semi-submersibles, drill ships, and the like.

Drilling rig 22 may be located proximate to or spaced apart from wellhead 24, such as in the case of an offshore arrangement. Drilling rig 22 may include rotary table 38, rotary drive motor 40, and other equipment associated with rotation and translation of drill string 32 within wellbore 60. Annulus 66 is formed between the exterior of drill string 32 and the inside wall of wellbore 60. For some applications, drilling rig 22 may also include a top drive unit 42. Pressure control devices 43, such as blowout preventers and other equipment associated with drilling a wellbore may also be provided at wellhead 24.

The lower end of drill string 32 may include bottom hole assembly 90, which may carry at a distal end a rotary drill bit 80. Drilling fluid 46 may be pumped to the upper end of drill string 32 and flow through the longitudinal interior 33 of drill string 32, through bottom hole assembly 90, and exit from nozzles formed in rotary drill bit 80. At bottom end 62 of wellbore 60, drilling fluid 46 may mix with formation cuttings and other downhole fluids and debris. The drilling fluid mixture may then flow upwardly through annulus 66 to return formation cuttings and other downhole debris to the surface.

Bottom hole assembly 90 may include a downhole mud motor. Bottom hole assembly 90 and/or drill string 32 may also include various other tools that provide information about wellbore 13, such as logging or measurement data from the bottom 62 of wellbore 60. Measurement data and other information may be communicated using measurement while drilling techniques using electrical signals or other telemetry that can be converted to electrical signals at the well surface to, among other things, monitor the performance of drilling string 32, bottom hole assembly 90, and associated rotary drill bit 80.

In particular, devices, including MWD, LWD instruments, detectors, circuits, or other tools may be provided within a sub 100, according to one or more embodiments described in greater detail below. Sub 100 may be located as part of bottom hole assembly 90 or elsewhere along drill string 32. Moreover, multiple subs 100 may be provided. Although described in conjunction with drilling system 20, sub 100 may be used in any appropriate system and carried along any type of string. Sub 100 may be used to house an instrument, tool, detector, circuitry, or any other suitable device.

In some embodiments, and with continuing reference to FIG. 1, sub 100 includes measuring instrument(s) (not shown) for measuring local gas values such as gas pressure, flow rate, quality, composition, energy content, and the like in real time. Optionally, sub 100 may communicate the local gas values to or as part of the automated lift-gas balancing system disclosed herein.

After an oil/gas reservoir is reached, drill string 32 including rotary drill bit 80 is retracted and a completion string (not shown) is inserted to activate oil/gas flow into the wellbore and up to wellhead 24. Optionally, the completion string may also measure and transmit local gas values including, for example, gas pressure and flow rate to or as part of the automated lift-gas balancing system disclosed herein.

Typically, drilling rig 22 is only on location during construction or drilling of the well. Once the well is finished, the rig is disassembled and moved to its next job site. All that remains is wellhead 24. However, for simplicity, pictures of drilling systems including drilling rigs and wellbores are shown as gas sources in figures of the lift-gas balancing system.

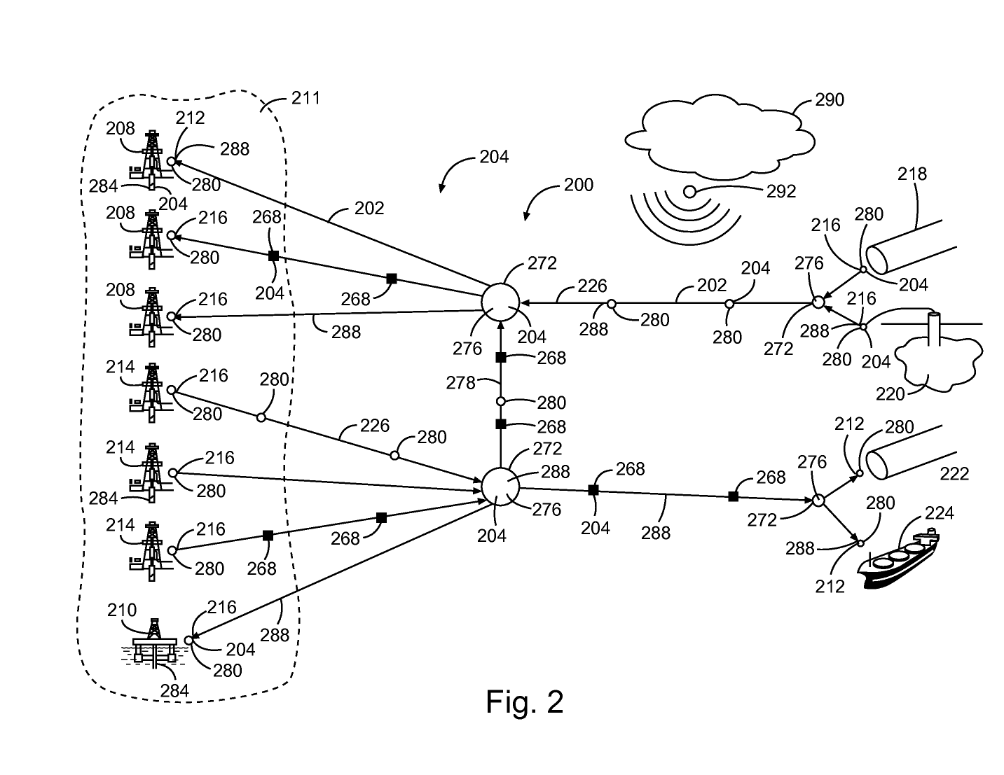

Referring to FIG. 2, an automated lift-gas balancing system 200 is shown. System 200 includes a gas pipeline network 202 and a communication and control network 204. In FIG. 2, communication and control network 204 includes all communication and control elements, e.g., sensors, flow control devices, a broadcast point, and the Internet, which will be further described later. However, for the sake of clarity of FIG. 2, only some representative examples of communication and control elements are labeled with reference number 204.

On-shore oil/gas wellheads 208 and a near off shore oil/gas wellhead 210 using lift gas for oil production in an oil field 211 are connected to the pipeline network 202 at gas output points 212. Oil field 211 includes other on-shore oil/gas wellheads 214 producing gas which may be recycled for use as lift gas, injected for reservoir pressure maintenance, stored, or else sold. These oil/gas wellheads 214 are also connected to the pipeline network 202 at gas import or input points 216.

A third-party pipeline 218 and an underground storage reservoir 220 are connected to the pipeline network at gas input points 216. The pipeline 218 and reservoir 220 are lift-gas sources that provide lift-gas to the local-field pipeline network 202 as needed. In other embodiments other lift-gas gas sources are used. It will be appreciated by those of ordinary skill in the art that the input and output points may be anywhere within the system 200.

Another third party pipeline 222 and an LNG (liquid natural gas) tanker 224 and associated liquefaction facility (not shown) are connected to the pipeline network at gas output points 212. The pipeline 222 and tanker 224 represent customers, receiving, transporting and/or storing gas for use in, for example, gas-fired power generators, manufacturing plants using gas furnaces, petrochemical plants, other lift-gas operations, and the like. Customers will have different demands or customer request parameters for their gas including, for example, one or more of a price, composition, energy content, quality, flow rate, total volume, and delivery timing. For example, customers may contract for (i) a certain price range, (ii) a methane composition of, for example, 85% or higher, and (iii) delivery from 1:00 pm to 4:00 pm on a certain day.

Between output points 212 and input points 216, the gas flows through flow lines, pipes, or pipelines 264 that make up pipeline network 202. In FIG. 2, arrows on pipelines 264 indicate gas flow direction at one point in time. It will be appreciated that the gas flow can reverse direction or stop at other points in time. Gas flow is maintained using (i) natural pressure or pumps (not shown) which lift reservoir fluids up through the wellbores and into the pipelines 264 and (ii) compressors 268 spaced along the pipelines 264.

Pumps and compressors 268 may operate at very high speeds (thousands of RPM) and, under the best of conditions, they have relatively predictable service lives (or “mean time to failure”). Bearings in the pumps and compressors are typically prone to failure. Bearings are used to align the pump or compressor or pump drive shaft in the correct position, and are lubricated to prevent friction from wearing away the shaft metal, which can lead to seal failure and fluid leakage. If there is a loss of lubrication oil, or if the oil becomes dirty or degrades chemically due to high temperatures, then the bearing surfaces will contact and grind against each other. Poor lubrication can also lead to misalignment of the drive shaft, causing the compressor or pump to vibrate, which may also shorten its useful life. Failure of the pump or compressor can lead to an unanticipated shutdown of a pipeline, stopping the flow of gas from a wellhead or otherwise stopping the flow of gas within the pipeline network. Unanticipated shutdowns due to equipment problems are a chronic source of production loss in gas wells and surface processing facilities.

Also in between the input points 216 and the output points 212 are nodes or junctions 272. In the context of a material supply network, such as the gas pipeline network 201, a junction is a point having any of a) two or more inputs and an output, b) an input and two or more outputs, or c) two or more inputs and two or more outputs. In the junctions, the gas is combined or divided. The junctions 272 include remotely-controllable junction flow control devices 276 including valves to increase or decrease gas flow into and out of the junctions through the pipelines connected thereto. The junction flow control devices 276 may be inside the junction or in the pipeline leading to/from the junction. In other embodiments, junctions 272 include proportional valves or valve systems that route different proportions of gas from selected inputs to selected outputs. For example, a junction having two input streams A and B and two output streams C and D can have its valve system settings adjusted so that output stream B comprises ¼ of stream A and ¾ of stream B while stream C comprises ¾ of stream A and ¼ of stream B. In other embodiments, junctions 272 include time division multiplexing valve systems that selectively close inputs and/or outputs to achieve a desired gas composition in one or more output streams.

Between two junctions 272 is an inter-junction pipe 278. In FIG. 2, the inter-junction pipe 278 is transferring gas from the lower junction 272 to the upper junction 272. However, it will be appreciated by those of ordinary skill in the art that, depending on the gas needs in the system 200, the inter-junction pipe 278 would transfer gas from the upper junction 272 to the lower junction 272, or not transfer gas at all.

Input points 216 and output points 212 also include remotely-controllable pipe flow control devices 280 to variably control the flow of gas through the points. The pipe flow control 280 devices may include actuators. Pipe flow control devices 280 are also at spaced locations along pipes in the pipeline network to control gas through the pipes, for example, to quickly stop flow of lift-gas to a well head in the event of a pipe rupture or well-head failure.

Generally, system 200 represents a system for balancing or optimizing the supply and demand of gas between input points 216 and export points 212. System 200 optimizes the flow of gas from all points within the system by controlling the flow control devices 276, 280 and compressors 268 in the pipeline network 202. System 200 also optimizes oil production from an oil field by controlling the amount of lift gas injected into lift-gas wells 208. To achieve this, communication and control network 204 receives the local gas values, local oil values, and customer request parameters, calculates target system values including target local oil values and target local gas values for the system 200, and automatically adjusts the flow of gas within the pipeline network 202 to meet the target values.

With continuing reference to FIG. 2, communication and control network 204 includes well oil and gas sensors 284 inside wellbores 208 or in adjacent pipe portions connected to wellbores 280. Communication and control network 204 also includes peer-to-peer pipeline gas sensors 288 throughout the pipeline network 202 including input points 216, output points 212, junctions 272, and spaced along pipes 226. For clarity, not all well sensors 284 and pipeline gas sensors 288 are shown in FIG. 2.

Well sensors 284 perform at least two functions: generate local oil values and local gas values; and transmit the local oil and gas values within the network 204. Local oil values include oil density and flow rate for the oil at the location of the sensor. Local gas values include gas pressure, flow rate, quality, composition, energy content, and the like.

Pipeline gas sensors 288 perform at least four functions: (i) generate local gas values for the gas at the sensor; (ii) receive system data including target local gas values for itself and for other sensors within the network 204; (iii) calculate local gas request parameters based on the local gas values and system data; and (iv) transmit the system data and local gas request parameters within the network 204. Generating local gas values includes determining real-time properties or characteristics of the gas, such as gas pressure, volume, and temperature (“PVT”) values or formulations, gas composition, gas energy content, and fluid phases. The sensor uses embedded software to continuously recalculate and broadcast the local gas values of fluid flowing by it in real time.

In other embodiments, gas sensors 288 at output points 212 of lift-gas wells 208 would detect differences between local gas values and target local gas values greater than a predetermined threshold, and then query nearby sensors at other wells, pipelines, compressors, junctions and input points to receive local gas values and local target gas values at those sensors, and based thereon, calculate how much lift gas to supply to the well.

In other embodiments, gas sensors 288 at output points 212 of lift-gas wells 208 calculate lift-gas requirements that are consistent with maximization of field level gas production within operational constraints. Examples of such constraints include: unavailability of a compressor due to maintenance or failure; changes in gas production by neighboring wells; changes in customer demand for gas; updates to system data including target local gas values received through communication and control network 204.

Transmitting the local gas values and local oil values by the well sensors and transmitting the system data and local gas request parameters by the pipeline sensors includes transmitting the data/values/parameters to or within the communication and control network 204 by wire or wirelessly via a wireless-fidelity (Wi-Fi) network, WiMAX network, cellular phone network or other network, and/or via other sensors which receive and retransmit the values of other sensors, and/or via pipes 226 that are electrically conductive The network 204 may include a public network such as the Internet or a private network. In FIG. 2, cloud 290 represents the Internet as well as connected computers or servers for remote processing of data relevant to system 200.

The sensors calculate target local gas values for at least all points where sensors are located to allow the system to meet lift-gas requirements for lift-gas wells, customer request parameters, and, optionally, oil production at the lowest cost and/or highest profit or revenue for an operator of the system. Calculating target local gas values includes, for example, calculating desired PVT parameters for the gas flowing through a pipeline portion at which a sensor is located.

Communication and control network 204 also includes broadcast server 292 which broadcasts system data to one or more pipeline gas sensors 288. The pipeline gas sensors 288 retransmit the systems data to other sensors in order to reach all sensors 288 in system 200. The system data includes customer request parameters, market data, event data, software updates, target local gas values, and the like. In other embodiments the system data includes target local oil values. Customer request parameters include gas quality, composition, volume, flow rate, price, and timing information. Event data includes events such as anticipated shutdowns of gas sources, pipelines, input points or output points due to, for example, decreasing well yield, scheduled maintenance, or closed supply contracts. Event data also includes events such as unanticipated shutdowns of gas sources, pipelines, input points or output points due to, for example, blowouts, delay in arrival of a tanker, or mechanical failure of pumps or compressors.

Market data includes streaming global and local price data, local actual or estimated storage volumes (e.g., estimated gas volumes accessible by wellheads 208, and actual gas volumes accessible from third-party pipeline 218 and underground storage reservoir 220 and/or cost of production data for produced gas within the system or cost of external gas from outside the system. Software updates includes new calibration software, lift-gas balancing software, and the like. Optionally, broadcast server 292 broadcasts override data to, for example, close all valves in a part of the pipeline network in the event of an accident.

It will be appreciated by one of ordinary skill in the art that in other embodiments, the wells, gas sources, input point, export points, and gas flow directions in the pipeline network of FIG. 2 change over time and with certain events. For example, as the natural pressure of a well decreases, a gas producing wellhead 214 can become a lift-gas wellhead 208. In such case, a pipeline initially carrying gas from the wellhead can change to carrying lift-gas to the wellhead. Similarly, third party pipeline 218 and underground storage reservoir 220 supplying gas to system 200 could instead, respectively, carry and store gas from system 200. Also, output points 21 for pipeline 222 and LNG tanker 224, if it has an associated regasification plant, could become input points if, for example, gas produced from wells falls too low or compressors from gas producing wells fail.

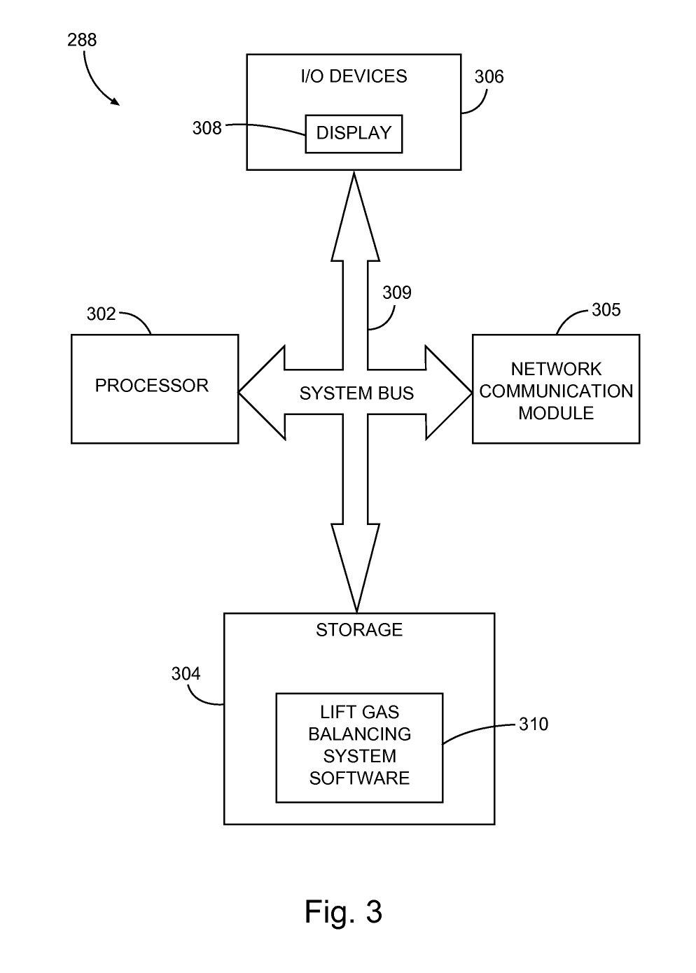

FIG. 3 is a block diagram of an exemplary pipeline gas sensor 288 adapted to implement the automatic lift-gas balancing system as described herein. Sensor 288 includes at least one processor 302 and a computer-readable storage 304. The computer-readable storage 304 contains a system memory, such as random access memory (RAM), and non-transitory memory such as an optical or magnetic storage device and a read-only memory (ROM). The sensor 288 also includes a network communication module 305, optional I/O devices 306, and an optional display 308 as one of the I/O devices, all interconnected via a system bus 309. System bus 309 represents all system, peripheral, and chipset buses that communicatively connect the number internal devices of sensor 288 including processor 302, storage 304, I/O devices 306 and network communication module 305. The network communication module 305 is operable to communicatively couple the sensor 288 to other sensor or computers over a communication and control network. In one embodiment, the network communication module 305 is a network interface card (NIC) and communicates using a Wi-Fi protocol. In other embodiments, the network communication module 305 may be another type of communication interface for use with a cellular phone network, Ethernet, or fiber optic cable, and may communicate using a number of different communication protocols. Sensor 288 may be connected to one or more public (e.g. the Internet 290) and/or private networks via the network communication module 305. Such networks may include, for example, servers containing customer request parameters or balancing algorithms.

Software instructions 310 executable by the processor 302 for implementing the lift-gas balancing system 200 in accordance with the embodiments described herein, may be stored in storage 304. The software may include software to, among other things, run compositional PVT correlations for the gas passing through the pipeline at the point at which the sensor is placed. It will be recognized that the lift-gas balancing system software 310 may be loaded into storage 304 through the network communication module 305, or from a FLASH memory drive, optical disc drive or other appropriate storage media. Processor 302 loads lift-gas balancing system software 310 and system data to execute processes in the subject disclosure. Processor 302 can be a single processor or a multi-core processor in different embodiments. ROM in storage 304 stores static data and instructions that are needed by processor 302 as well as other modules of sensor 288. System memory of storage 304 stores some of the instructions and data that the processor needs at runtime. In some implementations, the processes of the subject disclosure are stored in system memory and non-transitory memory of storage device 304.

Bus 309 also connects to input and output (I/O) devices 308 which can include interfaces. Input devices enable a user to communicate information and select commands to the system 200. Input devices used with input device interface 814 include, for example, alphanumeric, QWERTY, or T9 keyboards, microphones, and pointing devices. Output devices enable, for example, the display of images generated by sensor 288. Output devices include, for example, printers and display devices, such as liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described devices or interfaces.

In certain embodiments, sensor 288 may be an integrated unit while in other embodiments it may contain only a processor, ASICs, and associated computer hardware and software, while other components, such as storage 304 and I/O devices or interfaces 306 may be external thereto.

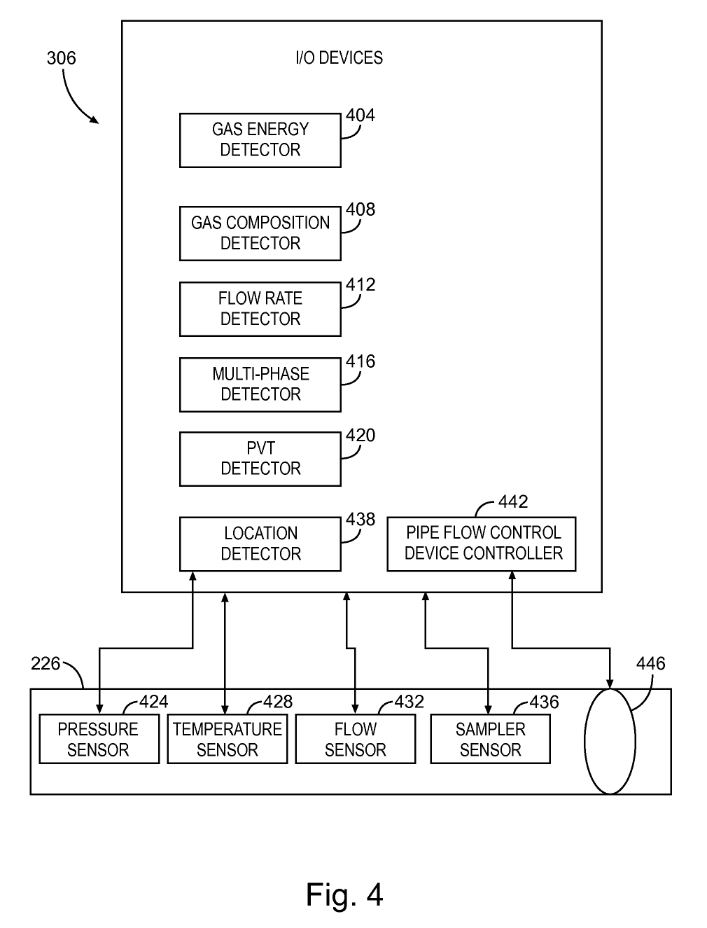

With reference to FIG. 4, to generate local gas values, the I/O devices 306 of sensor 288 include any or all of devices of or interfaces to a gas energy detector 404, a gas composition detector 408, a flow rate detector 412, a multi-phase detector 416, and a PVT detector 420. Gas energy detector 404 uses apparatuses and methods determinable by those of ordinary skill in the art such as acoustic or ultrasonic resonators and reference gases. Gas composition detector 408 uses apparatuses and methods determinable by those of ordinary skill in the art such as gas chromatography or infrared absorption spectroscopy. Flow rate detector 412 uses apparatuses and methods determinable by those of ordinary skill in the art such as venturi meters and differential pressure meters. Multi-phase detector 416 uses apparatuses and methods determinable by those of ordinary skill in the art such as producing a homogeneous sample of a a pressurized fluid stream flowing in a pipeline, injecting a surface active agent into the fluid stream, and sampling and analyzing a portion of the resulting fluid stream.

These detectors include application specific integrated circuits (ASICs) and associated electronics which receive and process sensor data or outputs from various sensors in and/or on associated pipe or pipeline 264 including a pressure sensor 424, temperature sensor 428, flow sensor 432 and sampler sensor 434. Based on this and optionally other sensor data, the detectors calculate local gas values. The sensors and detectors may be calibrated using, e.g., fluid samples analyzed a remote laboratory or using an artificial intelligence algorithm such as an embedded neural network program. It will be understood by those skilled in the art that gas values may be estimated or calculated from sensor data by processor 302, ASICs, field programmable gate arrays (FPGAs), or other processing devices.

I/O devices 306 also includes location detector 438. The detector includes an antenna or radiofrequency receiver for receiving location signals. Based on the signals, the detector determines its location relative to the earth or to the gas pipeline network 201. For example, the location detector may be a global positioning system (“GPS”) detector capable of receiving GPS satellite signals and determining its location based thereon.

I/O devices 306 also includes a pipe flow control device controller 446 such as a valve controller 442 which controls the opening and closing of pipe flow control device 446, such as a high-sensitivity proportional gas metering valve, in pipeline 226 based on pipe flow control device settings calculated from local gas request parameters, target local gas values, or other outputs of the lift-gas balancing system 200. For instance, if a local gas request parameter indicates that more lift-gas is needed, the valve could be opened wider to increase the supply of gas to the sensor that generated the local gas request parameter. More generally, with reference to FIG. 2, some or all of the pipeline gas sensors 288 are connected to pipe flow control devices to control the flow of gas at some or all points in the pipeline network 202 such as input points, output point, or junctions.

In the above embodiment, the sensor 288, detectors, and pipe flow control device 446 are directly electrically connected and relatively close to one another. In other embodiments, sensor 288 and its associated pipe flow control device 446 are remote from one another and/or connected wirelessly.

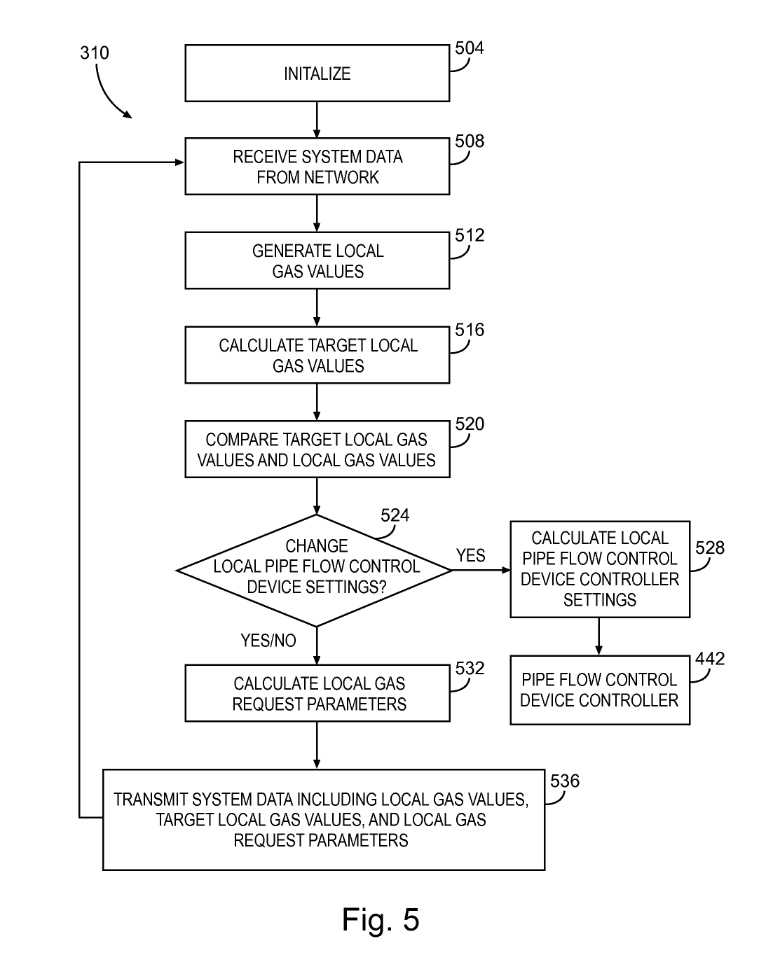

An analogue to sensor 288 is used for a junction flow control device 276 in system 200. In such analogue, sensor 288 includes a junction flow control device controller instead of a pipe flow device controller 446. FIG. 5 is an exemplary flow chart of the steps performed by the lift-gas balancing software 310 installed and executable on pipeline gas sensors 288 for implementing the lift-gas balancing system 200. The software may be one executable application or multiple executable applications. In step 504, the software causes the sensor to initialize which includes one or more of determining its location in the pipeline network 202, communicatively connecting to other sensors 288, receiving and installing any new or updated lift-gas balancing software 310, and calibrating WO devices and detectors.

Lift-gas balancing software 310 essentially balances two competing requirements to achieve total maximum oil and gas revenue or profit from the oil field The first is maximization of gas revenue. If gas, especially high quality gas, can be sold at a market price that results in more revenue than using the gas as lift gas to increase oil production, then the gas should be produced; otherwise, it should be used as lift gas. The second requirement is oil production maximization. Oil production will, in general, be a more heavily weighted part of the total maximum function. Oil production is increased by diverting more gas for use as lift gas, up to a point of diminishing returns. So, software 310 must continually decide whether each incremental amount of gas production should be sent to the export pipeline or to the lift gas pipeline. It makes this determination based on the availability and price (quality) of all available gas sources and the results of production forecasts from software models, and outputs local gas target values and optionally, local oil target values.

In step 508, sensor 288 receives system data from the network, i.e., from another sensor 288 or broadcast server 292. The system data includes customer request parameters, target local oil values, target local gas values, global and local market prices, local gas values from one or more sensors 288, locations of the sensors 288 within the gas pipeline network, local gas request parameters, and the like. In step 512, local gas values are generated based on the outputs from I/O devices 306 of the sensor 288. In step 516, target local gas values are calculated based on the system data which includes the local gas values generated at step 512 and local gas request parameters generated by other sensors. These target local gas values represent an optimal balancing of gas supply and gas demand in the pipeline network while minimizing operator's costs or maximizing the operator's oil and gas production, revenue or profit from the oil field. The calculation of the target local gas values and target local oil values can be performed by multivariable calculations or by solving linear or non-linear equations. The calculation of the target local gas values can include performing the Hardy Cross method.

In steps 520 and 524, target local gas values are compared to the local gas values to determine whether gas flowing through the pipeline associated with the sensor 280 should be changed, e.g., whether the local pipe flow control device settings should be changed to increase or decrease gas flow. If they should be changed, then at step 528, local pipe flow control device settings are calculated based on the results of the comparison of the target local gas values and the local gas values at step 520. The local pipe flow control device settings are communicated to pipe flow control device controller 442 which then adjusts pipe flow control device 446. In step 532, local gas request parameters are calculated based on the results of the comparison of the target local gas values and local gas values at step 520. In step 536, system gas data including updated local gas values, target local gas values and local gas request parameters are transmitted to other sensors via the communication and control network 204. Optionally, system data includes updated target local oil values. Steps 508 to 536 are repeated at a frequency dependent on hardware limitations such as the power supply for the sensor 288, energy efficiency of the communication, processing, and storage components in the sensor 288, and volatility or rate of meaningful changes of the local gas values and system data. In this manner, sensor 288 performs a feedback loop, repeatedly sensing local gas values and updating local gas request parameters to adjust gas delivery to the sensor and thus bring the local gas values closer to target local gas values. In one embodiment considering current technology and some historical gas data, the steps are repeated at a frequency of once every five minutes. However, it will be appreciated that this frequency may be increased or decreased. It will also be appreciated that the steps may be performed in a different order, and steps may be revised, added, replaced, or deleted. For instance, as an example of a revised step, in some embodiments, it may not be necessary to transmit local gas values or target local gas values per step 536.

In other embodiments, lift-gas balancing software 310 includes a step to determine whether override data has been received by sensor 288 and if so, directing the pipe flow control device controller 442 according to the data. In this way, the gas pipeline network may be quickly shut down in the event of an accident such as a pipeline rupture or fire. In other embodiments, sensor 288 and lift-gas balancing software 310 may perform steps to determine whether gas in a pipeline should be diverted to a treatment facility and if so, diverting the gas by controlling a diverter valve.

In other embodiments, a remote dashboard for system 200 would display indications representative of the differences between the local gas values and the local target gas values for at least the sensors at lift-gas wells so that a human operator could verify the extent to which overall gas production matches a forecasted optimum. In other embodiments, the operator could change the dashboard view to see instead how the forecasted optimum has changed based on lifting system or other operational constraints. Where long-range forecasts fall significantly below planned or achievable local gas values, the operator can seek to expand lift-gas capacity for the field, by for example, ordering more external gas via a gas truck or gas tanker.

In other embodiments, a remote dashboard for system 200 would display indications representative of the differences between the local oil values and the target local oil values for at least the sensors at lift-gas wells so that a human operator could verify the extent to which overall oil production matches a forecasted optimum.

In still other embodiments, a remote dashboard for system 200 would display both indications representative of the differences between local oil values and the target local oil values, as well as differences between local gas values and the local target gas values. In other embodiments, lift-gas balancing software 310 includes a step to compare local gas values from two different sensors on a single pipeline in order to determine whether the pipeline may have a leak, whether contaminants have entered the pipeline, and/or whether a sensor may be functioning improperly. For example, a sensor could have a faulty or improperly calibrated detector causing its generated local gas values to differ from the local gas values of a downstream sensor. If the local gas values from the two different sensors show a meaningful difference, then an alert can be sent to an operator to investigate the area between and surrounding the two sensors to identify and rectify the problem. In other embodiments, lift-gas balancing software 310 includes a step to determine whether a gas stream is the result of an unwanted comingling of gas streams. This can occur, for example, at the output of a junction 272.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of FIG. 5, as described above, may be implemented using any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

Thus, a system for balancing lift gas for a plurality of lift-gas oil wells of an oil field has been described. Embodiments of the system may include a pipeline network having a plurality of gas input points, a plurality of gas output points, and pipelines connected therebetween. The pipelines are interconnected by at least one junction. Each of the gas input points, gas output points and the at least one junction have a detector and a gas flow control device, both of which correspond to a unique one of a plurality of peer-to-peer sensors. Each of the plurality of sensors includes a communication network interface and a flow control device controller. Embodiments of the system may also include a plurality of lift-gas oil wells connected respectively to the plurality of gas output points and a communication and control network including the plurality of sensors. Each sensor is capable of repeatedly: (1) generating local gas values based on an output from the corresponding detector, the local gas values including one or more of gas PVT correlations, gas pressure values, gas density values, and gas flow rate values, (2) receiving system data via the communication network interface, the system data including local gas target values for each of the plurality of sensors and first local gas request parameters from at least one other sensor, (3) controlling the corresponding flow control device via the flow control device controller based on the local gas values and target local gas values for the sensor, and the first local gas request parameters, (4) calculating second local gas request parameters for the sensor based on the local gas values, the local target values, and the system data; and (5) transmitting the system data including the second local gas request parameters to at least one other sensor.

For any one of the foregoing embodiments, the system may include any one of the following elements, alone or in combination with each other: each sensor is capable of repeatedly performing the aforementioned steps at least once every five minutes; each sensor is also capable of repeatedly (6) calculating a difference between a local gas value and a local target gas value for the sensor, and if the difference is greater than a predetermined threshold, sending a local gas request parameter to at least one other sensor; the flow control device is one of a valve, a valve system, and a compressor; system data includes real-time gas market prices; system data includes real-time oil market prices; each sensor is capable of repeatedly, (6) based on system data, calculating one or more of a lowest cost, a highest revenue, a highest profit, and a highest production for the system, and target system values therefor, the target system values including target local gas values for each of the sensors; each of the plurality of sensors includes a storage for storing lift-gas balancing software capable of, on execution, causing the sensor to perform steps (1) to (5); a broadcast point separate from a sensor, the broadcast point capable of broadcasting broadcast data including an update to the lift-gas balancing software, and including system data including one or more of target local gas values, customer request parameters and gas market prices; the sensor includes a location detector capable of generating a location of the sensor relative to the pipeline network for associating with the local gas values; a wellbore sensor for generating and transmitting local oil values to a sensor inside wellbores or in adjacent pipe portions connected to the wellbores.

A method for controlling gas flows from gas input points to gas output points in a lift-gas pipeline network of an oil field has been described. Embodiments of the method may include: transmitting and retransmitting system data for the pipeline network through a communication and control network including a plurality of peer-to-peer sensors connected to the pipeline network, the system data including local oil values, target local oil values, local gas values, target local gas values, and local gas request parameters; sensing properties of gas flowing through the pipeline network at a first peer-to-peer sensor of the plurality of sensors and generating first local gas values therefrom; generating first local gas request parameters based on the system data and the first local gas values; transmitting the first local gas request parameters from the first sensor to a second peer-to-peer sensor of the plurality of sensors; receiving the first local gas request parameters at the second sensor; controlling gas flow through the pipeline network at the location of the second sensor based on the first local gas request parameters; sensing properties of gas flowing through the pipeline network at the second sensor and generating second local gas values therefrom; generating second local gas request parameters based on the system data and the second local gas values; and, transmitting the second local gas request parameters to a third peer-to-peer sensor of the plurality of sensors.

For the foregoing embodiments, the method may include any one of the following steps, alone or in combination with each other: based on system data, calculating (i) one of a highest revenue, highest production and highest profit for the oil field, and (ii) target local gas values that meet (i); transmitting lift-gas balancing software from the first sensor to the second sensor; storing the software on the second sensor; and executing the software on the second sensor; broadcasting broadcast data from a broadcast point separate from any sensor to the first sensor, the broadcast data including the one or more of customer request parameters, gas market prices, event data, and lift-gas balancing software.

A sensor for controlling gas flows in a gas pipeline network of an oil field has been described. The gas pipeline network has a plurality of gas input points, a plurality of gas output points, and pipelines connected therebetween. The pipelines are interconnected by at least one junction. Each of the gas input points, gas output points and junction having a gas property sensor and a flow control device. Embodiments of the sensor include: an input interface for operatively coupling with a gas property detector in a pipeline network and receiving detector data; a network communication module for receiving system data including first local gas request parameters, and for transmitting system data including second local gas request parameters; a first calculator for calculating flow rate controller device settings based on the detector data, the system data, and the first local gas request parameters; a flow rate controller device controller for operatively coupling with a flow rate controller device and for controlling it based on the flow rate controller device settings; and a second calculator for calculating the second local gas request parameters based on the system data and the detector data.

For any of the foregoing embodiments, the sensor may include any one of the following elements, alone or in combination with each other: a processor and a storage for storing lift-gas balancing software, the processor for executing the lift-gas balancing software, the processor including the first calculator and the second calculator; the network module is also for receiving broadcast data from a broadcast point separate from another sensor, the broadcast data including one or more of target local oil values, customer request parameters, gas market prices, and an update to the lift-gas balancing software; the flow control device is one of a valve, a valve system, and a compressor; system data includes real-time oil market prices, real-time gas market prices and customer request parameters; a third calculator for calculating, based on the system data, (i) one of a highest revenue, highest production and highest profit of the oil field and (ii) target local gas values that meet (i); a location detector capable of generating a location of the sensor for including in the system data; and a fourth calculator for calculating, based on system data, target local oil values.

The embodiments set forth herein are merely illustrative and do not limit the scope of the disclosure or the details therein. It will be appreciated that many other modifications and improvements to the disclosure herein may be made without departing from the scope of the disclosure or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed is:

1. A system for balancing lift gas for a plurality of lift-gas oil wells of an oil field, the system comprising:
a pipeline network having a plurality of gas input points, a plurality of gas output points, and pipelines connected therebetween, the pipelines interconnected by at least one junction, each of the gas input points, gas output points and the at least one junction having a detector and a gas flow control device, both of which correspond to a unique one of a plurality of peer-to-peer sensors, each of the plurality of sensors including a communication network interface and a flow control device controller;
a plurality of lift-gas oil wells connected respectively to the plurality of gas output points;
a communication and control network including the plurality of sensors, each sensor capable of repeatedly: (1) generating local gas values based on an output from the corresponding detector, the local gas values including one or more of gas PVT correlations, gas pressure values, gas density values, and gas flow rate values, (2) receiving system data via the communication network interface, the system data including local gas target values for each of the plurality of sensors and first local gas request parameters from at least one other sensor, (3) controlling the corresponding flow control device via the flow control device controller based on the local gas values and target local gas values for the sensor, and the first local gas request parameters, (4) calculating second local gas request parameters for the sensor based on the local gas values, the local target values, and the system data; and (5) transmitting the system data including the second local gas request parameters to at least one other sensor.

2. The system of claim 1 wherein repeatedly includes at least once every five minutes.

3. The system of claim 1 wherein each sensor is also capable of repeatedly (6) calculating a difference between a local gas value and a local target gas value for the sensor, and if the difference is greater than a predetermined threshold, sending a local gas request parameter to at least one other sensor.

4. The system of claim 1 wherein the flow control device is one of a valve, a valve system, and a compressor.

5. The system of claim 1 wherein system data includes real-time gas market prices.

6. The system of claim 1, wherein each sensor is capable of repeatedly: (6) based on system data, calculating one or more of a lowest cost, a highest revenue, a highest profit, and a highest production for the system, and target system values therefor, the target system values including local gas target values for each of the sensors.

7. The system of claim 1 wherein each of the plurality of sensors includes a storage for storing lift-gas balancing software capable of, on execution, causing the sensor to perform steps (1) to (5).

8. The system of claim 1 further including a broadcast point separate from a sensor, the broadcast point capable of broadcasting broadcast data including an update to the lift-gas balancing software, and including system data including one or more of target local gas values, customer request parameters and gas market prices.

9. The system of claim 1 wherein the sensor includes a location detector capable of generating a location of the sensor relative to the pipeline network for associating with the local gas values.

10. A method for controlling gas flows from gas input points to gas output points in a lift-gas pipeline network of an oil field comprising:
transmitting and retransmitting system data for the pipeline network through a communication and control network including a plurality of peer-to-peer sensors connected to the pipeline network, the system data including local oil values, target local oil values, local gas values, target local gas values, and local gas request parameters;
sensing properties of gas flowing through the pipeline network at a first peer-to-peer sensor of the plurality of sensors and generating first local gas values therefrom;
generating first local gas request parameters based on the system data and the first local gas values;
transmitting the first local gas request parameters from the first sensor to a second peer-to-peer sensor of the plurality of sensors;
receiving the first local gas request parameters at the second sensor;
controlling gas flow through the pipeline network at the location of the second sensor based on the first local gas request parameters;
sensing properties of gas flowing through the pipeline network at the second sensor and generating second local gas values therefrom;
generating second local gas request parameters based on the system data and the second local gas values; and,
transmitting the second local gas request parameters to a third peer-to-peer sensor of the plurality of sensors.

11. The method of claim 10, further comprising:
based on system data, calculating (i) one of a highest revenue, highest production and highest profit for the oil field, and (ii) target local gas values that meet (i).

12. The method of claim 10 further comprising:
transmitting lift-gas balancing software from the first sensor to the second sensor;
storing the software on the second sensor; and
executing the software on the second sensor.

13. The method of claim 10 further comprising:
broadcasting broadcast data from a broadcast point separate from any sensor to the first sensor, the broadcast data including the one or more of customer request parameters, gas market prices, event data, and lift-gas balancing software.

14. A sensor for controlling gas flows in a gas pipeline network of an oil field, the gas pipeline network having a plurality of gas input points, a plurality of gas output points, and pipelines connected therebetween, the pipelines interconnected by at least one junction, each of the gas input points, gas output points and junction having a gas property sensor and a flow control device, the sensor comprising:
an input interface for operatively coupling with a gas property detector in a pipeline network and receiving detector data;
a network communication module for receiving system data including first local gas request parameters, and for transmitting system data including second local gas request parameters;
a first calculator for calculating flow rate controller device settings based on the detector data, the system data, and the first local gas request parameters;
a flow rate controller device controller for operatively coupling with a flow rate controller device and for controlling it based on the flow rate controller device settings; and
a second calculator for calculating the second local gas request parameters based on the system data and the detector data.

15. The sensor of claim 14 further comprising a processor and a storage for storing lift-gas balancing software, the processor for executing the lift-gas balancing software, the processor including the first calculator and the second calculator.

16. The sensor of claim 14 wherein the network module is also for receiving broadcast data from a broadcast point separate from another sensor, the broadcast data including one or more of target local oil values, customer request parameters, gas market prices, and an update to the lift-gas balancing software.

17. The sensor of claim 14 wherein the flow control device is one of a valve, a valve system, and a compressor.

18. The sensor of claim 14 wherein system data includes real-time oil and gas market prices, and customer request parameters.

19. The sensor of claim 14, further comprising a third calculator for calculating, based on the system data, (i) one of a highest revenue, highest production and highest profit of the oil field and (ii) target local gas values that meet (i).

20. The sensor of claim 14 further comprising a location detector capable of generating a location of the sensor for including in the system data.
